(19) United States
(12) Patent Application Publication
(10) Pub. No.: US 2007/0090253 A1
(43) Pub. Date: Apr. 26, 2007

(54) ADJUSTABLE CLAMP FOR CYLINDRICAL OBJECT

(76) Inventor: Andrew Feinberg, El Paso, TX (US)

Correspondence Address: CONNOLLY BOVE LODGE & HUTZ LLP, P.O. BOX 2207, WILMINGTON, DE, 19899-2207, US

(21) Appl. No.: 11/163,664

(22) Filed: Oct. 26, 2005

(51) Int. Cl. F16B 45/00

(52) U.S. Cl. 248/307

(57) ABSTRACT

A clamp for a cylindrical object is adapted for mounting to a surface and includes a hose clamp having a metal strap for encircling a cylindrical object. The strap includes a plurality of spaced openings for meshing with a worm gear member rotationally mounted in a rider that is slidably positionable along the length of the strap. An over-center double bail is pivotally mounted to the rider and has a first section secured at opposite ends thereof to the rider. A bight portion of the first section serves as a lever. A second section of the bail is generally U-shaped and has opposite free ends thereof pivotally mounted to respective points along legs of the first section for facilitating engagement of a bight portion of the second section over an upturned edge of the strap. A mounting bracket is perpendicularly attached to the strap.

### FIELD OF THE INVENTION

The present invention relates to adjustable clamps and more particularly to an adjustable clamp suited to fasten cylindrical objects.

### SUMMARY OF THE INVENTION

In the mounting of cylindrical objects, for example, a fire extinguisher to a structural member, a mounting bracket is frequently employed. The bracket has an attached adjustable clamp and the purpose of the clamp is to accommodate the cylindrical object and fasten it to the bracket.

In these typical types of installations, the clamp is specifically sized for the particular cylindrical dimension and there is little latitude in terms of cylindrical objects of various sizes. Therefore, for example, when using fire extinguishers, differently sized fire extinguishers require differently sized corresponding clamping members.

It would be desirable to provide a clamping member that can accommodate differently sized cylindrical objects. This would improve the logistical problems of manufacturing and stocking different sized clamping members by manufacturers and consumers.

### BRIEF DESCRIPTION OF THE INVENTION

Taking into consideration the deficiencies of the current art, the present invention provides a clamping member that principally relies upon a conventional hose clamp to which an over center double bail is provided as a lever actuator to clamp confronting ends of a hose clamp strap snuggly about the periphery of a cylindrical object, such as a fire extinguisher.

The hose clamp offers a significant latitude in effective length while the over center double bail has inherent elasticity so as to further increase the range of clamping action.

Consequently, the present invention can be adjusted to accommodate a wide range of cylindrical object diameters and achieves flexibility in the manufacturer and inventory of mounts for such cylindrical objects.

An apparatus according to the present invention will now be described, by way of example, with reference to the accompanying drawings.

### BRIEF DESCRIPTION OF THE FIGURES

FIG. 1 is an elevational view of the present invention indicating a supported fire extinguisher (in dotted lines).

FIG. 2 is a perspective view of the present clamp attached to a vertical support for a cylinder.

### DETAILED DESCRIPTION OF THE INVENTION

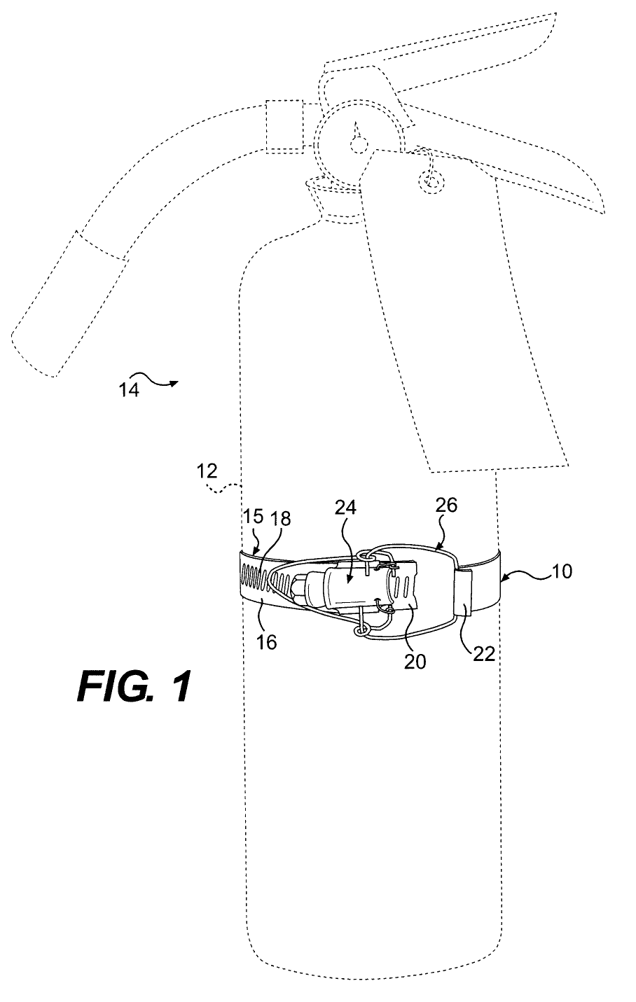

The present cylinder clamp as shown in FIG. 1 by reference numeral 10. Shown dotted is a cylindrical body 12 of the fire extinguisher 14, the later merely being an example of a cylinder capable of support by the present invention.

Clamp 10 includes a conventional hose clamp 15 including a strap 16 that incorporates slots 18 along the length thereof. The strap of the hose clamp has an end 20 confronting an oppositely disposed upturned free end 22 of the hose clamp 15.

An adjustably positionable hose clamp rider 24 is mounted on the strap 16 and is adjustably displaced along the length thereof and is used to provide an effective clamp length around the cylinder.

In order to pull the opposing ends 20 and 22 of the hose clamp 15 together, an over center double bail 26 is employed.

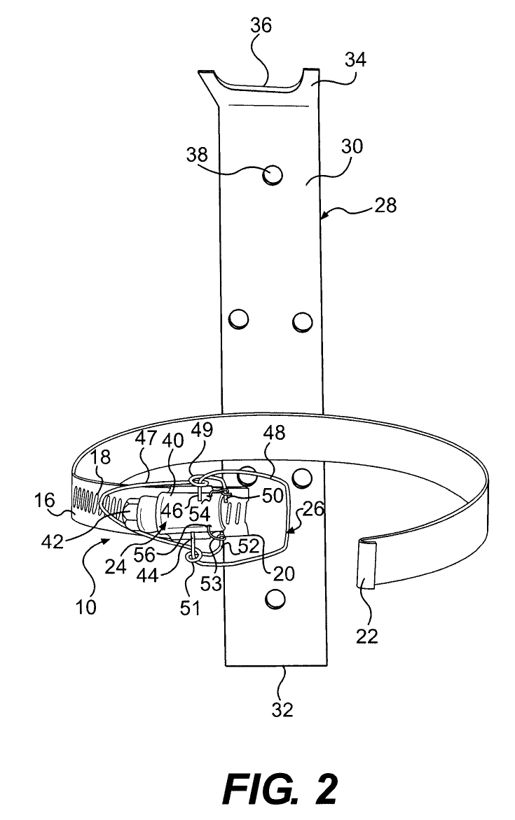

FIG. 2 shows the construction of the present clamp in greater detail. As will be observed, the clamp may be employed with a vertical bracket currently indicated by reference numeral 28. The bracket includes a body 30 having mounting screws 38 formed therealong. The lower end 32 of the bracket is positioned below the clamp while the upper end 34 may include a notch 36 for accommodating a constrained surface of a mounted cylinder, such as the neck of a fire extinguisher.

The barrel shaped body 40 of rider 24 incorporates a conventional worm gear member (not shown) so as to allow the rider 24 to be repositioned along the strap 16 by engaging matching slots 18. The movement is actuated by screwing the head 42 of the worm gear in rider 24. The head may be a conventional six sided screw head or other type of fastener such as a thumb screw.

The over center double bail 26 includes two generally U-shaped engaged bails 47 and 48. Bail 47 includes intermediate looped sections 49 and 51 located toward the free ends 50 and 52 thereof. These looped sections receive the free ends 44 and 46 of bail 48. This connection permits the bails 47 and 48 to pivot with respect to one another.

The double bail combination is secured to the body 40 of rider 24 by means of forming small holes 56 and 54 in the body 40. A small wire 53 passes through the hole 56 and extends within the body 40 where it exits at hole 54. The ends of the wire 53 crimp ends 50 and 52 of bail 47 so as to pivotally mount the engaged bails 48 and 47 to the rider 24.

In operation of the device, a cylinder is positioned against the bracket 28 and the opened clamp 10 is then closed around the body of the cylinder. The screw 42 is adjusted so as to approximate the closed diameter of the strap 16 that matches the diameter of the cylinder. The bight section of bail 48 is positioned over upturned end 22 while the bail 47 is in an opened positioned. Then, the bail 47 is pushed down toward the strap 16 so as to snuggly execute an over center motion and securement of the cylinder within the clamp. The operation is reversed to free the cylinder from the clamp.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed as new and desired to be protected by Letters Patent of the United States is:

1. A clamp for a cylindrical object, the clamp comprising:
a metal strap for encircling a cylindrical object;
a rider slidably positionable along the length of the strap;
one end of the strap having an upturned edge;
an over-center double bail being pivotally mounted to the rider;
the bail having a bight portion slipped over the upturned edge for pulling the upturned end tightly toward an opposite end of the strap thereby clamping a cylindrical object within the strap.

2. The clamp of claim 1 wherein the strap includes a plurality of spaced openings for meshing with a worm gear member rotationally mounted in the rider.

3. The clamp of claim 1 wherein the bail includes
a first section secured at opposite ends thereof to the rider, a bight portion of the first section serving as a lever; and
a second section of the bail being generally U-shaped and having opposite ends thereof pivotally mounted to respective points along legs of the first section for facilitating the bight portion of the second section to be slipped over the upturned edge.

4. The clamp of claim 1 together with a bracket perpendicularly attached to an intermediate section of the strap to allow securement of the clamp to a mounting surface.

5. The clamp of claim 1 together with a wire connector secured in the rider for rotationally mounting the over center double bail to the rider.

6. The clamp of claim 1 together with a fastener mounted to the gear worm for rotating the gear worm resulting in movement of the rider along the strap.

7. The clamp of claim 6 wherein the fastener is a screw having a polygonal shaped head.

8. The clamp of claim 6 wherein the fastener is thumb screw.

9. A clamp for a cylindrical object adapted for mounting to a mounting surface and comprising:
a hose clamp having a metal strap for encircling a cylindrical object, wherein the strap includes a plurality of spaced openings for meshing with a worm gear member rotationally mounted in a rider slidably positionable along the length of the strap;
an over center double bail pivotally mounted to the rider and having
a first section secured at opposite ends thereof to the rider, a bight portion of the first section serving as a lever; and
a second section of the bail being generally U-shaped and having opposite free ends thereof pivotally mounted to respective points along legs of the first section for facilitating engagement of a bight portion of the second section over an upturned edge of the strap;
and a bracket attached to an intermediate section of the strap to allow securement of the clamp to a mounting surface.

10. The clamp of claim 9 wherein the rider includes a fastener attached to the worm gear for rotating the gear and adjusting the position of the rider along the length of the strap.
